(19) United States
(12) Patent Application Publication
(10) Pub. No.: US 2010/0053537 A1
(43) Pub. Date: Mar. 4, 2010

(54) VERTICAL ALIGNMENT LIQUID CRYSTAL DISPLAY PANEL AND LIQUID CRYSTAL MATERIAL THEREOF

(75) Inventors: Chung-Ching HSIEH, Hsin-Chu (TW); Chia-Hsuan PAI, Hsin-Chu (TW); Yang-Chu LIN, Hsin-Chu (TW); Chih-Ho CHIU, Hsin-Chu (TW); Jia-Hau JIAN, Hsin-chu (TW); Te-Sheng CHEN, Hsin-Chu (TW); Norio SUGIURA, Hsin-Chu (TW)

Correspondence Address: RABIN & Berdo, PC, 1101 14TH STREET, NW, SUITE 500, WASHINGTON, DC, 20005, US

(73) Assignee: AU OPTRONICS CORP., Hsin-Chu (TW)

(21) Appl. No.: 12/534,835

(22) Filed: Aug. 3, 2009

(30) Foreign Application Priority Data
Sep. 3, 2008 (TW) TW-97133818

(51) Int. Cl. C09K 19/02; C09K 19/30

(52) U.S. Cl. 349/182; 252/299.01; 252/299.63

(57) ABSTRACT

A vertical alignment liquid crystal display panel (LCD) panel is provided. The vertical alignment LCD panel comprising a lower substrate, an upper substrate and a liquid crystal layer interposed between the two substrates. The liquid crystal layer comprises a plurality of liquid crystal molecules and an alignment polymer. The liquid crystal molecules comprise a plurality of neutral liquid crystal molecules and negative liquid crystal molecules, wherein the negative liquid crystal molecules are about 51 to 85 weight percents of the liquid crystal layer.

This application claims the benefit of Taiwan application Serial No. 97133818, filed Sep. 3, 2008, the subject matter of which is incorporated herein by reference.

### BACKGROUND OF THE INVENTION

1. Field of the Invention

The invention relates in general to a liquid crystal display (LCD) panel and a liquid crystal material thereof, and more particularly to a vertical alignment LCD panel and a liquid crystal material thereof.

2. Description of the Related Art

Liquid crystal display (LCD) panel, having the features of light weight, low power consumption and low radiation, has been widely used in commercial and consumer electronics to replace conventional cathode ray tube (CRT) monitor and has become a very popular optico-electric device. Currently, the LCD panel is superior to conventional CRT monitor in terms of power consumption, overall brightness and contrast but is still inferior to conventional CRT monitor in terms of response time.

Two important aspects regarding the quality of LCD panel are the display quality of dynamic images and the occurrence of Mura. The display quality of dynamic images is mainly related to, firstly, the motion blur problem which occurs when the fast motion images displayed on the LCD panel but the response rate of liquid crystal molecules is too slow, and, secondly, the image sticking problem which occurs if previous image stays for a long duration of time and is overlapped with the subsequent image when an image displayed on the LCD panel over a long duration is switched to another image. Mura refers to the areas with non-uniformed brightness which occurs when the LCD panel displays static images with low brightness (i.e, grey level 92, grey level 128).

How to improve the display quality of motion and static images for LCD panel has always been a focus to the manufacturers, but, however, the reason for low quality of motion ans statice images is still unclear. Let the occurrence of Mura be taken for example. Some ascribe Mura to the defects during assembly process, but some ascribe it to inconsistent cell gaps, therefore different solutions are provided accordingly. For example, some adopt stricter conditions of manufacturing process, and some add an additional process to adjust the cell gap. However, many difficulties arise when these solutions are used in the production of large-scaled panels or used in large-scale production. It is both time-consuming and costive to apply severely control over every step of the manufacturing process without a definite direction. As panel size becomes larger and larger, cell gaps will inevitably increase, and it is more and more difficult trying to improve display quality by way of adjusting cell gaps.

### SUMMARY OF THE INVENTION

The invention is directed to a vertical alignment liquid crystal display (LCD) panel and a liquid crystal material thereof. The neutral liquid crystal molecules and the negative liquid crystal molecules are mixed in the liquid crystal layer according to a pre-determined proportion so as to resolve the problem of non-uniformed brightness.

According to a first aspect of the present invention, a vertical alignment LCD panel comprising a lower substrate, an upper substrate and a liquid crystal layer interposed between the two substrates is provided. The liquid crystal layer comprises a plurality of liquid crystal molecules and an alignment polymer. The liquid crystal molecules comprise a plurality of neutral liquid crystal molecules and negative liquid crystal molecules, wherein the negative liquid crystal molecules are about 51 to 85 weight percents of the liquid crystal layer.

According to a second aspect of the present invention, a liquid crystal material used in a vertical alignment LCD panel is provided. The liquid crystal material comprises a plurality of polymerizable monomers and liquid crystal molecules. The liquid crystal molecules comprise a plurality of neutral liquid crystal molecules and negative liquid crystal molecules, wherein the negative liquid crystal molecules are about 51˜85 weight percents of the liquid crystal material.

The invention will become apparent from the following detailed description of the preferred but non-limiting embodiments. The following description is made with reference to the accompanying drawings.

### BRIEF DESCRIPTION OF THE DRAWINGS

FIG. 1 shows a side view of a vertical alignment LCD panel according to a preferred embodiment of the invention;

FIG. 2 shows the ingredients and their proportions of a liquid crystal layer of the vertical alignment LCD panel according to a preferred embodiment of the invention; and

FIG. 3 shows a comparison table of the proportion of negative liquid crystal molecules in a liquid crystal material vs. the likelihood of Mura under the same manufacturing conditions.

### DETAILED DESCRIPTION OF THE INVENTION

Liquid crystal molecules are divided into positive liquid crystal molecules, neutral liquid crystal molecules and negative liquid crystal molecules according to their dielectric anisotropy values. Positive liquid crystal molecules refer to the liquid crystal molecules whose dielectric anisotropy values are positive, and when a voltage larger than a predetermined level is applied to positive liquid crystal molecules, the long axis of liquid crystal molecules will be parallel to the direction of the electrical field. Neutral liquid crystal molecules refer to the liquid crystal molecules whose dielectric anisotropy values are near zero, and when a voltage larger than a predetermined level is applied to neutral liquid crystal molecules, the long axis of liquid crystal molecules has very limited rotation. Negative liquid crystal refer to the liquid crystal molecules whose dielectric anisotropy values are negative, and when a voltage larger than a predetermined level is applied to negative liquid crystal molecules, the long axis of liquid crystal molecules will be perpendicular to the direction of the electrical field.

Vertical alignment LCD panel refers to an LCD panel which, in a natural state (when no voltage is applied), displays a black image when the long axis of liquid crystal molecules is perpendicular to the substrate. However, the inventor finds out that the display quality is not the best when the liquid crystal layer of the vertical alignment LCD panel is entirely constituted by negative liquid crystal molecules,. Therefore, the invention provides a criterion regarding the constituting proportion for the liquid crystal layer/the liquid crystal material of a vertical alignment LCD panel. Such criterion is: when the negative liquid crystal molecules are about 51 to 85 weight percents of the liquid crystal material, the display quality of LCD panel can be further improved.

The invention mainly provides a vertical alignment LCD panel. The neutral liquid crystal molecules and the negative liquid crystal molecules are mixed in a liquid crystal layer according to a pre-determined proportion so as to resolve the problem of non-uniformed brightness or image sticking.

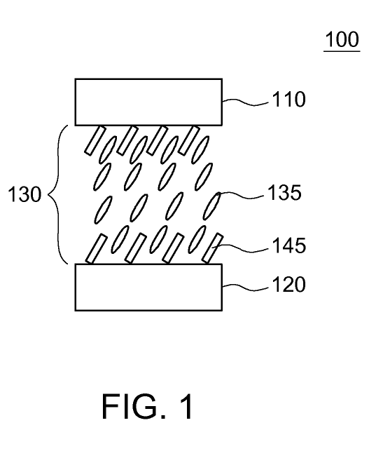

Referring to FIG. 1, a side view of a vertical alignment LCD panel according to a preferred embodiment of the invention is shown. The vertical alignment LCD panel 100 of a preferred embodiment of invention includes a lower substrate 120, an upper substrate 110 and a liquid crystal layer 130 interposed between the two substrates. The liquid crystal layer includes a plurality of liquid crystal molecules 135 and an alignment polymer 145. The alignment polymer 145 is constituted by a plurality of polymerizable monomers and formed on the surface of the upper substrate 110 or the lower substrate 120 by polymer-stabilizing alignment (PSA) technology. The alignment polymer 145 is used for guiding the arrangement of the liquid crystal molecules 135 and for forming a pre-determined tilting angle with the substrate. The liquid crystal molecules 135 include a plurality of neutral liquid crystal molecules and negative liquid crystal molecules, and the negative liquid crystal molecules are about 51 to 85 weight percents of the liquid crystal layer. Preferably, the negative liquid crystal molecules are about 55˜75 weight percents of the liquid crystal material. It is even better if the negative liquid crystal molecules are about 60˜65 weight percents of the liquid crystal material.

The chemical structures of the neutral liquid crystal molecules and the negative liquid crystal molecules are disclosed below. The negative liquid crystal molecules are selected from at least one of a compound I, a compound II, a compound III-A or a compound IV-A. The neutral liquid crystal molecules are selected from at least one of a compound III-B or a compound IV-B. The compound III or the compound IV is further divided into compounds III-A and III-B or compounds IV-A and IV-B by its substituent groups. The compounds III-A and IV-A are negative liquid crystal molecules, and compounds III-B and IV-B are neutral liquid crystal molecules. Both neutral and negative liquid crystal molecules can be selected from the compound III or the compound IV. Of the negative liquid crystal molecules, the compound III-A and the compound IV-A have a negative substituent group such as fluorine substituent group (—F) for example.

The compound I is expressed as the following chemical formula:

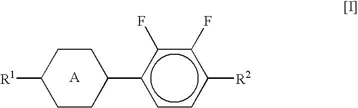

The compound II is expressed as the following chemical formula:

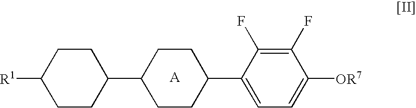

The compound III-A is expressed as the following chemical formula:

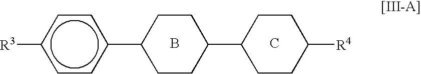

The compound IV-A is expressed as the following chemical formula:

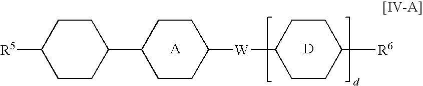

Wherein, d=0 or 1.

“R¹”, “R²”, “R³”, “R⁴” and “R⁶” independently denote alkyl with 1˜12 carbon atoms, in which one or two nonadjacent of —CH₂— group is replaced by oxygen atom, vinylene (—CH═CH—), carbonyl (C═O) or carboxyl (—COO—,—OCO—).

“R⁵” denotes alkyl with 1˜8 carbon atoms or alkenyl with 2˜8 carbon atoms.

“R⁷” denotes alkyl with 1˜12 carbon atoms.

“W” denotes oxygen atom, sulfur atom, methyoxy (—OCH₂—), carbonyl (C═O), carboxyl (—COO—), carbamoyl (—CO—N⁰R—, —N⁰R—CO—), methylthio (—CH₂S—, —SCH₂—), ethenylcarbonyl (—CH═CH—COO—), carbonylethenyl (—COO—CH═CH—) or a single bond.

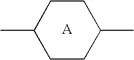

denotes 1,4-cyclohexylene(1,4-cyclohexylene) or 1,4-phenylene.

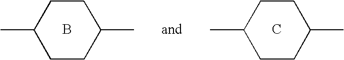

independently denote

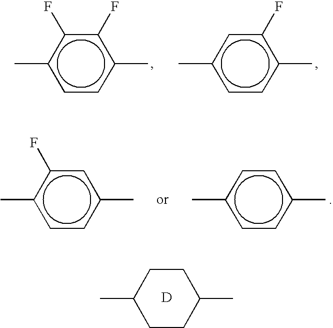

denotes

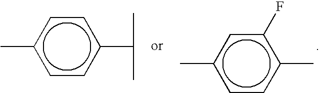

It is noted that the compound IV-A is at most about 20 weight percents of the liquid crystal layer when the compound IV-A is selected from at least one of a compound IV-a, a compound IV-b, a compound IV-c and a compound IV-d.

The compound IV-a is expressed as the following chemical formula:

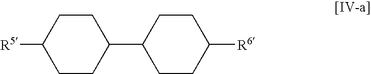

The compound IV-b is expressed as the following chemical formula:

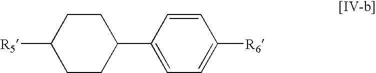

The compound IV-c is expressed as the following chemical formula:

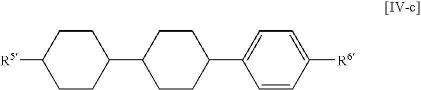

the compound IV-d is expressed as the following chemical formula:

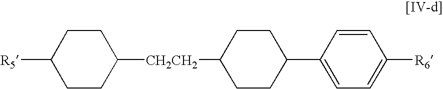

Wherein, “R^{5′}” denotes alkenyl with 2˜8 carbon atoms, and “R^{6′}” denotes alkyl with 1˜8 carbon atoms.

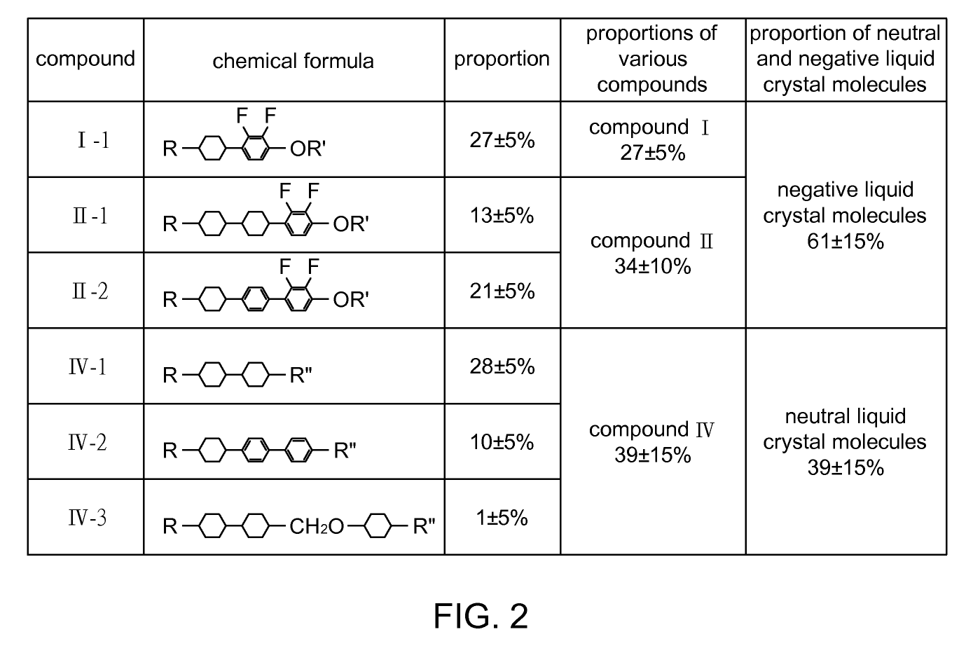

Apart from the rule that the negative liquid crystal molecules are about 51˜85 weight percents of the liquid crystal material, there are restrictions regarding the proportions between various compounds such as the compound I, the compound II, the compound III-A and the compound IV-A. The compound I at most is about 50 weight percents of the liquid crystal layer, the compound II at most is about 50 weight percents of the liquid crystal layer, the compound III-A at most is about 20 weight percents of the liquid crystal layer, and the compound IV-A at most is about 50 weight percents of the liquid crystal layer. For example, the liquid crystal layer of the vertical alignment LCD panel of the invention may include the compound I-1, the compound II-1, the compound II-2, the compound IV-1, the compound IV-2 and the compound IV-3, and the chemical formulas and proportions of these compounds are summarized in FIG. 2. Besides, to simplify the chemical formulas such that these compounds can be likened to particular types of compounds, “R” and “R′” independently denote alkyl with 1˜12 carbon atoms and “R″” denotes alkyl with 1˜12 carbon atoms or alkoxy group in the following compounds.

The compound I-1 (expressed as chemical formula [I-1] below) belongs to the compound I, wherein

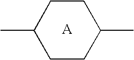

denotes 1,4-cyclohexylene, “R¹” denotes alkyl (denoted as “R”) with 1˜12 carbon atoms, “R²” denotes alkyl with 2˜12 carbon atoms, and the first —CH₂— group connected to benzene ring is replaced by oxygen atom and denoted as “OR′”. The compound I-1 is about 22˜32 weight percents of the liquid crystal material and meets the above criterion that the compound I is at most about 50 weight percents of the liquid crystal layer.

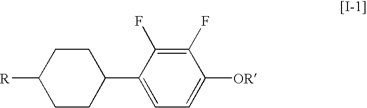

The compound II-1 (expressed as chemical formula [II-1] below) belongs to the compound II, wherein

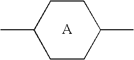

denotes 1,4-cyclohexylene, “R¹” denotes alkyl (denoted as “R”) with 1˜12 carbon atoms, “R⁷” denotes alkyl with 2˜12 carbon atoms, and the first —CH₂— group connected to benzene ring is replaced by oxygen atom and denoted as “OR′”. The compound II-1 is about 8˜18 weight percents of the liquid crystal material.

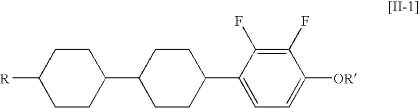

The compound II-2 (expressed as chemical formula [II-2] below) also belongs to the compound II, wherein

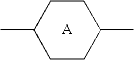

denotes

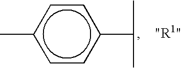

denotes alkyl (denoted as “R” ) with 1˜12 carbon atoms, “R⁷” denotes alkyl with 2˜12 carbon atoms and the first —CH₂— group connected to benzene ring is replaced oxygen atom and denoted as “OR′”. The compound II-2 is about 16˜26 weight percents of the liquid crystal material

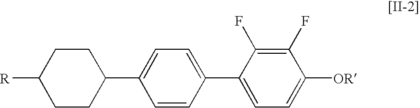

Besides, the compounds II-1 and II-2 both belong to the compound II, and their summation is preferably about 24˜44 weight percents of the liquid crystal material and matches the above criterion that the compound II at most is about 50 weight percents of the liquid crystal layer

The compound IV-1 (expressed as chemical formula [IV-1] below) belongs to the compound IV-a, wherein d=0,

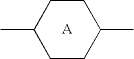

denotes 1,4-cyclohexylene, “W” denotes single bond, “R⁵” denotes alkyl (denoted as “R”) with 1˜12 carbon atoms, “R⁶” denotes alkyl or alkoxy group (denoted as “R″”) with 1˜12 carbon atoms. The compound IV-1 is about 23˜33 weight percents of the liquid crystal material.

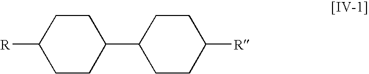

The compound IV-2 (expressed as chemical formula [IV-2] below) belongs to the compound IV-b, wherein d=1,

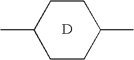

denotes

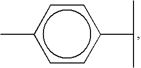

“W” denotes a single bond,

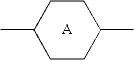

denotes 1,4-cyclohexylene, “W” denotes a single bond, “R⁵” denotes alkyl (denoted as “R”) with 1˜12 carbon atoms, and “R⁶” denotes alkyl or alkoxy group (denoted as “R″”) with 1˜12 carbon atoms. The compound IV-2 is about 5˜15 weight percents of the liquid crystal material.

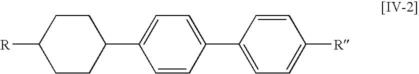

The compound IV-3 (expressed as chemical formula [IV-3] below) belongs to the compound IV-c, wherein d=1,

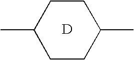

denotes

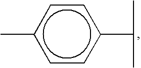

“W” denotes methyoxy

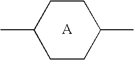

denotes 1,4-cyclohexylene, “R⁵” denotes alkyl with 1˜12 carbon atoms (denoted as “R”), and “R⁶” denotes alkyl or alkoxy group (denoted as “R″”) with 1˜12 carbon atoms. The compound IV-3 at most is about 7 weight percents of the liquid crystal material.

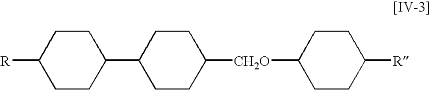

As the compound IV-A at most is about 50 weight percents of the liquid crystal layer, all the three compounds IV-1, IV-2 and IV-3 belong to the compound IV-A, and their summation preferably is about 24˜50 weight percents of the liquid crystal material. Besides, as the three compounds IV-1, IV-2 and IV-3 are not selected from at least one of a compound IV-a, a compound IV-b, and a compound IV-c, the compound IV-A does not need to be reduced to be below 20 weight percents of the liquid crystal layer.

The chemical structure of neutral liquid crystal molecules may be at least one of a compound III-B or a compound IV-B. The compound III or the compound IV is further divided into compounds III-A and III-B or compounds IV-A and IV-B by its substituent groups. Compounds III-A and IV-A are negative liquid crystal molecules, and compounds III-B and IV-B are neutral liquid crystal molecules. When the dielectric anisotropy values of the compounds III-B and IV-B are near zero, the liquid crystal molecules are neutral liquid crystal molecules.

The compound III-B is expressed as the following chemical formula:

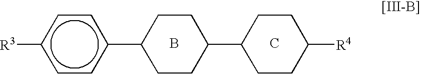

The compound IV-B is expressed as the following chemical formula:

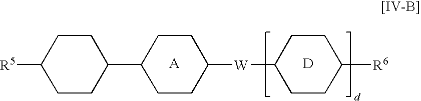

Wherein, d=0 or 1, and other functional groups are similar to the compounds III-A and IV-A.

When all the three compounds I-1, II-1 and II-2 of the above material belong to negative liquid crystal molecules, all the three compounds IV-1, IV-2 and IV-3 belong to neutral liquid crystal molecules. Referring to FIG. 2, in the material of the liquid crystal layer of the invention, the negative liquid crystal molecules are about 61±15 weight percents of the liquid crystal layer.

According to the object of the invention, a liquid crystal material including a plurality of polymerizable monomers and liquid crystal molecules is provided. The liquid crystal molecules include a plurality of neutral liquid crystal molecules and negative liquid crystal molecules, and the negative liquid crystal molecules are about 51˜85 weight percents of the liquid crystal material. The liquid crystal material is interposed between the lower substrate and the upper substrate. An alignment polymer is constituted by a plurality of polymerizable monomers by polymer-stabilizing alignment (PSA) technology. Thus, the liquid crystal layer of a vertical alignment LCD panel of a preferred embodiment of the invention is formed. Except for the differences in the alignment polymer and the polymerizable monomers, the liquid crystal material of the present embodiment of the invention is similar to the liquid crystal layer disclosed above, and is not repeated here.

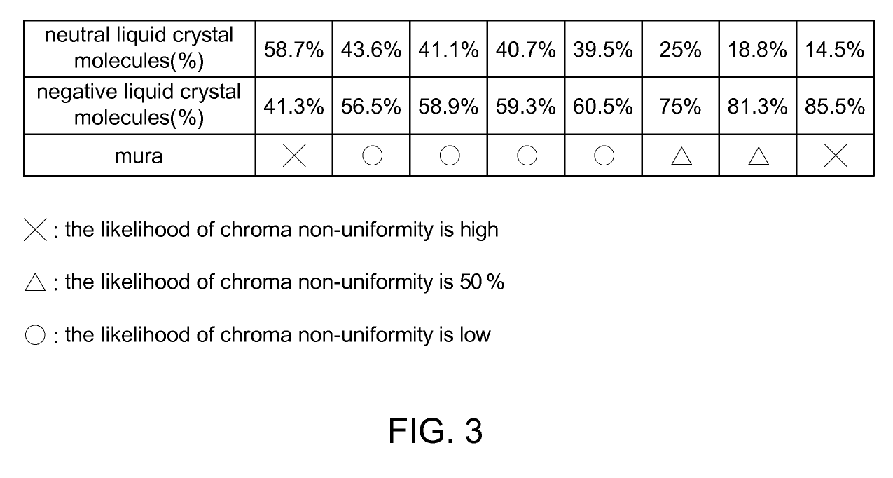

The relationship between the proportion of negative liquid crystal molecules and display performance is tested and several experimental results are given below. Of the testing groups, the negative liquid crystal molecules are 41, 56.5, 58.9, 59.3, 60.5, 75, 81.3 and 85.5 weight percents of the liquid crystal material. After a plurality of vertical alignment LCD panels are manufactured according to the same manufacturing conditions, the likelihood that Mura occurs to a manufactured vertical alignment LCD panel is tested and calculated, and the results are summarized in FIG. 3.

Referring to FIG. 3, a comparison table of the proportion of negative liquid crystal molecules in a liquid crystal material vs. the likelihood of Mura under the same manufacturing conditions is shown. When the proportion of negative liquid crystal molecules is 41.3%, the likelihood of Mura occurring to the LCD panel is the largest, and a defected product with non-uniformed brightness will be resulted. As the proportion of negative liquid crystal molecules gradually increases, the likelihood of Mura occurring to the LCD panel will diminish until the proportion of negative liquid crystal molecules reaches 85.5%, then the likelihood of Mura occurring to the LCD panel will turn to increase. Thus, the negative liquid crystal molecules preferably are about 51˜85 weight percents of the liquid crystal layer. The negative liquid crystal molecules can be used in a vertical alignment LCD panel to avoid the problems of chroma non-uniformity and image sticking. Preferably, when the negative liquid crystal molecules are about 55˜75 weight percents of the liquid crystal material, the likelihood of Mura occurring to the LCD panel is very low, so the problem of chroma non-uniformity is unlikely to occur. Thus, the manufactured products can seldom be defective despite the manufacturing conditions become looser. In other words, when the negative liquid crystal molecules are abut 55˜75 weight percents of the liquid crystal material, the manufacturing process of LCD panel can adopt looser manufacturing conditions. For example, although the ventilation process is omitted or the drying time is shortened after liquid crystal molecules are added, the manufactured product can still have acceptable display quality.

According to the vertical alignment LCD panel and the liquid crystal material thereof disclosed in the above embodiment of the invention, the neutral liquid crystal molecules and the negative liquid crystal molecules are mixed in the liquid crystal layer according to a pre-determined proportion so as to resolve the problem of non-uniformed brightness occurring to the LCD panel and improve display quality. Compared with the conventional method which adopts stricter manufacturing process or controls cell gap, the manufacturing method of the present embodiment of the invention adopts a simple manufacturing process in which the neutral liquid crystal molecules and the negative liquid crystal molecules are mixed according to a pre-determined proportion so as to improve the display quality of static images, such that the manufacturing method of the present embodiment of the invention can be easily used in the manufacturing process of large-scaled panels. When the negative liquid crystal molecules are about 51 to 85 weight percents of the liquid crystal layer, the problem of non-uniformed brightness is improved. Preferably, the negative liquid crystal molecules are 55˜75 weight percents of the liquid crystal material. When the negative liquid crystal molecules are 60˜65 weight percents of the liquid crystal material, the display quality of static images is even better and the likelihood of Mura is further lower. Particularly, the manufacturing process of LCD panel can adopt looser manufacturing conditions. For example, despite the ventilation process is omitted or the drying time is shortened after liquid crystal molecules are added, the manufactured product can still have acceptable display quality.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A vertical alignment liquid crystal display (LCD) panel, comprising:
a lower substrate and an upper substrate; and
a liquid crystal layer interposed between the upper substrate and the lower substrate, wherein the liquid crystal layer comprises a plurality of liquid crystal molecules and an alignment polymer, the liquid crystal molecules comprise a plurality of neutral liquid crystal molecules and negative liquid crystal molecules, and the negative liquid crystal molecules are about 51 to 85 weight percents of the liquid crystal layer.

2. The LCD panel according to claim 1, wherein the negative liquid crystal molecules are about 55 to 75 weight percents of the liquid crystal material

3. The LCD panel according to claim 1, wherein the negative liquid crystal molecules are about 60 to 65 weight percents of the liquid crystal material.

4. The LCD panel according to claim 1, wherein the negative liquid crystal molecules are selected from at least one of a compound I, a compound II, a compound III or a compound IV;
the compound I being expressed as the following chemical formula: 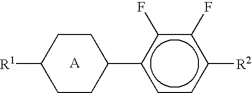
the compound II being expressed as the following chemical formula: 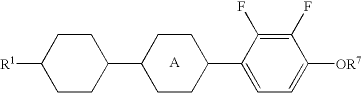
the compound III being expressed as the following chemical formula: 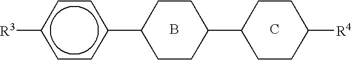
the compound IV being expressed as the following chemical formula: 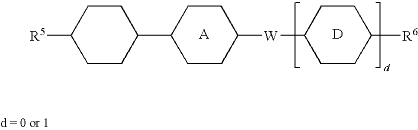
wherein,
“R¹”, “R²”, “R³”, “R⁴” and “R⁶” independently denote alkyl with 1˜12 carbon atoms, one or two nonadjacent of —CH₂— groups thereof being replaced by oxygen atom, vinylene, carbonyl or carboxyl;
“R⁵” denotes alkyl with 1˜8 carbon atoms or alkenyl with 2˜8 carbon atoms;
“R⁷” denotes alkyl with 1˜12 carbon atoms;
“W” denotes oxygen atom, sulfur atom, methyoxy, carbonyl, carboxyl carbamoyl, methylthio, ethenylcarbonyl, carbonylethenyl or a single bond; 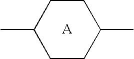
denotes 1,4-cyclohexylene or 1,4-phenylene; 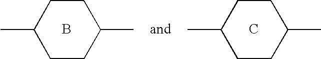
independently denote 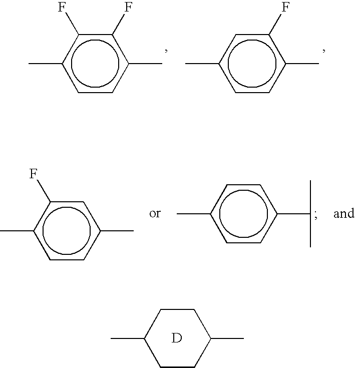
denotes

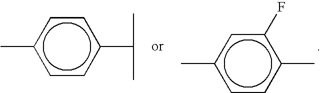

5. The LCD panel according to claim 4, wherein the compound I at most is about 50 weight percents of the liquid crystal layer, the compound II at most is about 50 weight percents of the liquid crystal layer, the compound III at most is about the 20 weight percents of the liquid crystal layer, and the compound IV at most is about 50 weight percents of the liquid crystal layer.

6. The LCD panel according to claim 4, wherein when the compound IV is selected from at least one of a compound IV-a, a compound IV-b, a compound IV-c or a compound IV-d, the compound IV being at most about the 20 weight percents of the liquid crystal layer;
the compound IV-a being expressed as the following chemical formula: 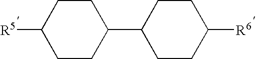
the compound IV-b being expressed as the following chemical formula: 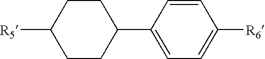
the compound IV-c being expressed as the following chemical formula: 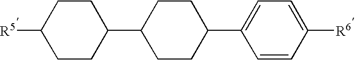
the compound IV-d being expressed as the following chemical formula: 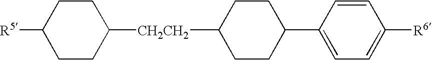
wherein,
“R^{5′}” denotes alkenyl with 2˜8 carbon atoms; and
“R^{6′}” denotes alkyl with 1˜8 carbon atoms.

7. The LCD panel according to claim 4, wherein the liquid crystal layer comprises:
a compound I-1 belonging to the compound I and being about 22 to 32 weight percents of the liquid crystal material, the compound I-1 expressed as the following chemical formula: 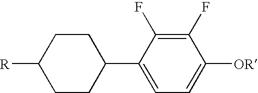
a compound II-1 belonging to the compound II and being about 8 to 18 weight percents of the liquid crystal material, the compound II-1 expressed as the following chemical formula: 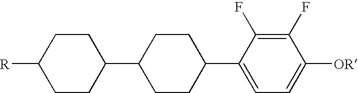
a compound II-2 belonging to the compound II and being about 16 to 26 weight percents of the liquid crystal material, the compound II-2 expressed as the following chemical formula: 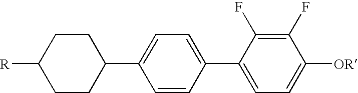
a compound IV-1 belonging to the compound IV and being about 23 to 33 weight percents of the liquid crystal material, the compound IV-1 expressed as the following chemical formula: 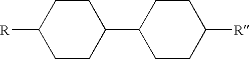
a compound IV-3 belonging to the compound IV and being about 5 to 15 weight percents of the liquid crystal material, the compound IV-3 expressed as the following chemical formula: 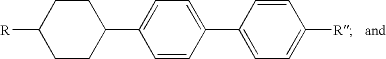
a compound IV-3 belonging to the compound IV and being at most about 7 weight percents of the liquid crystal material, the compound IV-3 expressed as the following chemical formula: 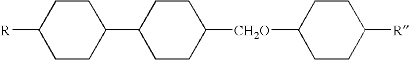
wherein,
“R” and “R′” independently denote alkyl with 1˜12 carbon atoms; and
“R″” denotes alkyl with 1˜12 carbon atoms or alkoxy group.

8. The LCD panel according to claim 1, wherein the neutral liquid crystal molecules are selected from at least one of a compound III or a compound IV:
the compound III being expressed as the following chemical formula: 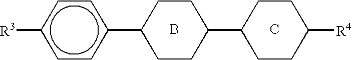
the compound IV being expressed as the following chemical formula: 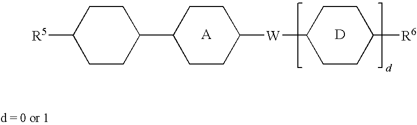
wherein,
“R³”, “R⁴” and “R⁶” independently denote alkyl with 1˜12 carbon atoms;
“R⁵” denotes alkyl with 1˜8 carbon atoms or alkenyl with 2˜8 carbon atoms;
“W” denotes oxygen atom sulfur atom methyoxy carbonyl, carboxyl, carbamoyl, methylthio, ethenylcarbonyl, carbonylethenyl or a single bond; and 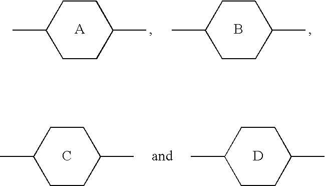
independently denote 1,4-cyclohexylene or 1,4-phenylene.

9. The LCD panel according to claim 1 further comprising:
an initiator used for absorbing optical energy or heat energy to activate a polymerization reaction on the polymerizable monomers, the initiator at most being about 0.002 weight percents of the liquid crystal material.

10. A liquid crystal material used in a vertical alignment LCD panel, wherein the liquid crystal material comprises:
a plurality of polymerizable monomers; and
a plurality of liquid crystal molecules comprising a plurality of neutral liquid crystal molecules and negative liquid crystal molecules, wherein the negative liquid crystal molecules are about 51 to 85 weight percents of the liquid crystal material.

11. The liquid crystal material according to claim 10, wherein the negative liquid crystal molecules are about 55 to 75 weight percents of the liquid crystal material.

12. The liquid crystal material according to claim 10, wherein the negative liquid crystal molecules are about 60 to 65 weight percents of the liquid crystal material.

13. The liquid crystal material according to claim 10, wherein the negative liquid crystal molecules are selected from at least one of a compound I, a compound II, a compound III or a compound IV;
the compound I being expressed as the following chemical formula: 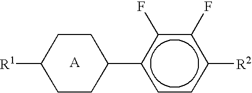
the compound II being expressed as the following chemical formula: 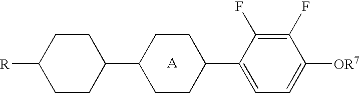
the compound III being expressed as the following chemical formula: 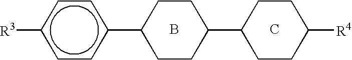
the compound IV being expressed as the following chemical formula: 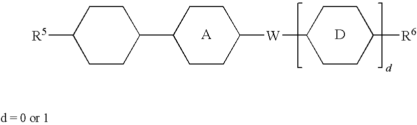
wherein,
“R¹”, “R²”, “R³”, “R⁴” and “R⁶” independently denote alkyl with 1˜12 carbon atoms, one or two nonadjacent of —CH₂— groups thereof being replaced by oxygen atom, vinylene, carbonyl, or carboxyl;
“R⁵” denotes alkyl with 1˜8 carbon atoms or alkenyl with 2˜8 carbon atoms;
“R⁷” denotes alkyl with 1˜12 carbon atoms;
“W” denotes oxygen atom, sulfur atom, methyoxy, carbonyl, carboxyl, carbamoyl, methylthio, ethenylcarbonyl, carbonylethenyl or a single bond; 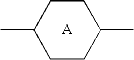
denotes 1,4-cyclohexylene or 1,4-phenylene; 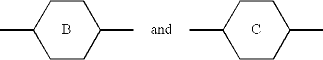
independently denote 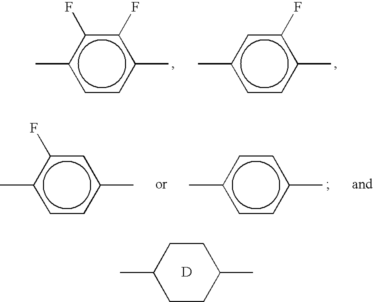
denotes

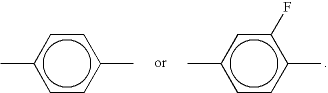

14. The liquid crystal material according to claim 13, wherein the compound I at most is about 50 weight percents of the liquid crystal material, the compound II at most is about 50 weight percents of the liquid crystal material, the compound III at most is about 20 weight percents of the liquid crystal material, and the compound IV at most is about 50 weight percents of the liquid crystal material

15. The liquid crystal material according to claim 13, wherein when the compound IV is selected from at least one of a compound IV-a, a compound IV-b, a compound IV-c and a compound IV-d, and the compound IV is at most about 20 weight percents of the liquid crystal material;
the compound IV-a being expressed as the following chemical formula: 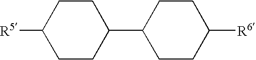
the compound IV-b being expressed as the following chemical formula: 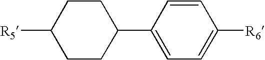
the compound IV-c being expressed as the following chemical formula: 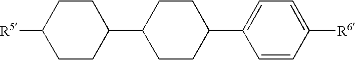
the compound IV-d being expressed as the following chemical formula: 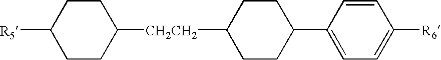
wherein,
“R^{5′}” denotes alkenyl with 2˜8 carbon atoms; and
“R^{6′}” denotes alkyl with 1˜8 carbon atoms;

16. The liquid crystal material according to claim 13, wherein the liquid crystal material comprises:
a compound I-1 belonging to the compound I and being about 22˜32 weight percents of the liquid crystal material, the compound I-1 expressed as the following chemical formula: 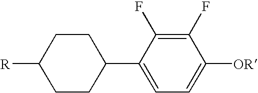
a compound II-1 belonging to the compound II and being about 8˜18 weight percents of the liquid crystal material, the compound II-1 expressed as the following chemical formula: 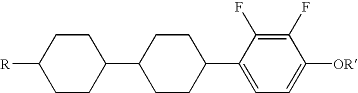
a compound II-2 belonging to the compound II and being about 16˜26 weight percents of the liquid crystal material, the compound II-2 expressed as the following chemical formula: 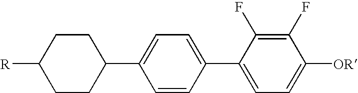
a compound IV-1 belonging to the compound IV and being about 23˜33 weight percents of the liquid crystal material, and the compound IV-1 expressed as the following chemical formula: 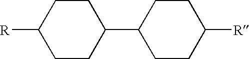
a compound IV-2 belonging to the compound IV and being about 5 to 15 weight percents of the liquid crystal material, the compound IV-2 expressed as the following chemical formula: 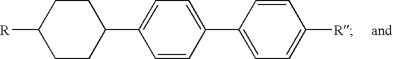
a compound IV-3 belonging to the compound IV and being at most about 7 weight percents of the liquid crystal material, the compound IV-3 expressed as the following chemical formula: 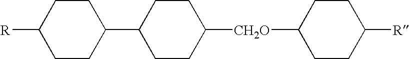
wherein,
“R” and “R′” independently denote alkyl with 1˜12 carbon atoms; and
“R″” denotes alkyl with 1˜12 carbon atoms or alkoxy group.

17. The liquid crystal material according to claim 10, wherein the neutral liquid crystal molecules is selected from at least one of a compound III or a compound IV:
the compound III being expressed as the following chemical formula: 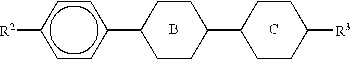
the compound IV being expressed as the following chemical formula: 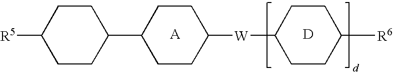
d=0 or 1
wherein,
“R³”, “R⁴” and “R⁶” independently denote alkyl with 1˜12 carbon atoms;
“R⁵” denotes alkyl with 1˜8 carbon atoms or alkenyl with 2˜8 carbon atoms;
“W” denotes oxygen atom, sulfur atom, methyoxy, carbonyl, carboxyl, carbamoyl, methylthio, ethenylcarbonyl, carbonylethenyl or a single bond; 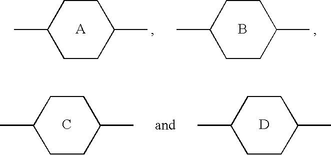
independently denote 1,4-cyclohexylene or 1,4-phenylene

18. The liquid crystal material according to claim 10 further comprising:
an initiator used for absorbing optical energy or heat energy to activate a polymerization reaction on the polymerizable monomers, the initiator at most being about 0.002 weight percents of the liquid crystal material.
